(19) United States
(12) Patent Application Publication
(10) Pub. No.: US 2011/0058221 A1
(43) Pub. Date: Mar. 10, 2011

(54) APPARATUS AND METHOD FOR DISPLAYING AND STORING SCAN IMAGES

(76) Inventor: Thomas SHENG, Hsinchu (TW)

(21) Appl. No.: 12/873,750

(22) Filed: Sep. 1, 2010

(30) Foreign Application Priority Data
Sep. 7, 2009 (TW) 098129994

(51) Int. Cl. G06K 15/00

(52) U.S. Cl. 358/1.16

(57) ABSTRACT

An apparatus for displaying and storing scan images includes an image capturing module, a processor module and a display module. The image capturing module captures N images of N pages of a document and generates corresponding N sets of image data, where N is a positive integer greater than 2. The processor module, coupled to the image capturing module, controls the image capturing module, processes the N sets of image data and generates corresponding storage image data and M representation images of M of the N images, where M is a positive integer less than N. The display module, coupled to the processor module, displays the M representation images after the storage image data are stored in a memory device connected to the apparatus. A method for displaying and storing the scan images is also disclosed.

This application claims priority of No. 098129994 filed in Taiwan R.O.C. on Sep. 7, 2009 under 35 USC 119, the entire content of which is hereby incorporated by reference.

### BACKGROUND OF THE INVENTION

1. Field of the Invention

The invention relates to an apparatus and a method for displaying and storing scan images.

2. Related Art

Conventionally, the scanner driver and the image processing program are installed in a computer in order to control the scanner and process the scan image data through the computer. However, in such case, the computer may display only a single thumbnail image of the first page of the scan image data, even for multi-page images, or an icon, to indicate the completion of the scan operation, by which users are not able to examine the correctness of each image without opening the data files.

### SUMMARY OF THE INVENTION

It is therefore an object of the invention to provide an apparatus and a method for displaying and storing scan images, so that a user can verify that the scan images are correct and are properly processed and stored during and after the scanning operation.

To achieve the above-identified object, the invention provides an apparatus for displaying and storing scan images. The apparatus includes an image capturing module, a processor module and a display module. The image capturing module captures N images of N pages of a document and generates corresponding N sets of image data, where N is a positive integer greater than 2. The processor module, coupled to the image capturing module, controls the image capturing module, processes the N sets of image data and generates corresponding storage image data and M representation images of M of the N images, where M is a positive integer less than N. The display module, coupled to the processor module, displays the M representation images after the storage image data are stored in a memory device connected to the apparatus.

The invention also provides a method for displaying and storing scan images, used in an apparatus. The method includes the steps of: capturing N images of N pages of a document and generating N sets of image data, where N is a positive integer greater than 2; generating storage image data corresponding to the N sets of image data and storing the storage image data; generating M representation images of M of the N images, where M is a positive integer less than N; and displaying the M representation images after the storage image data are stored.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing an apparatus for displaying and storing scan images according to the invention.

FIGS. 2 to 5 show several operation states in the apparatus according to the invention.

FIG. 6 is a flow chart showing a method for displaying and storing the scan images according to the invention.

### DETAILED DESCRIPTION OF THE INVENTION

The present invention will be apparent from the following detailed description, which proceeds with reference to the accompanying drawings, wherein the same references relate to the same elements.

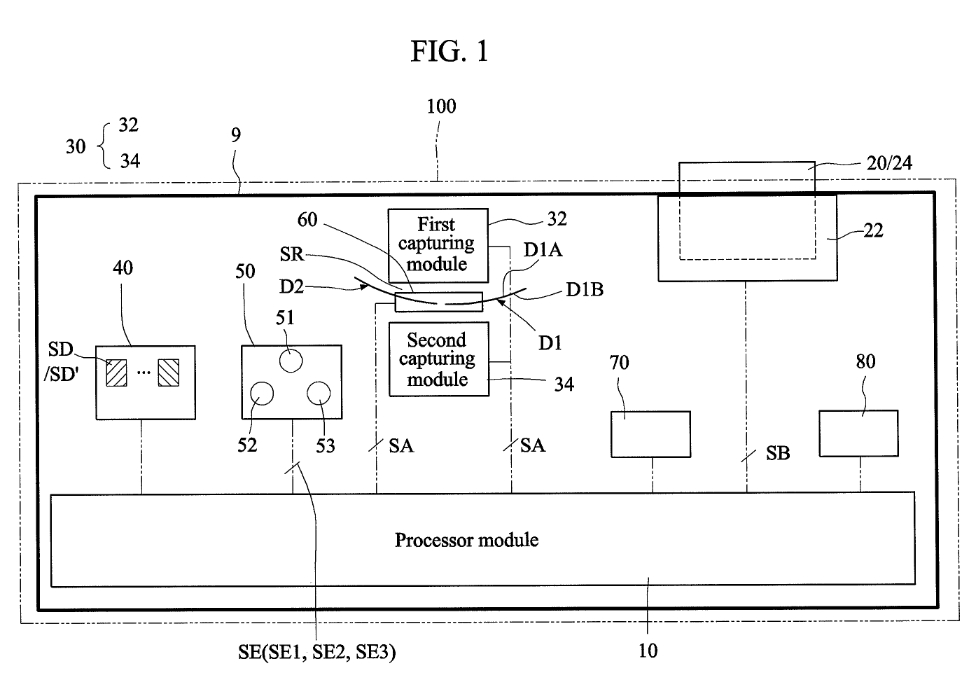

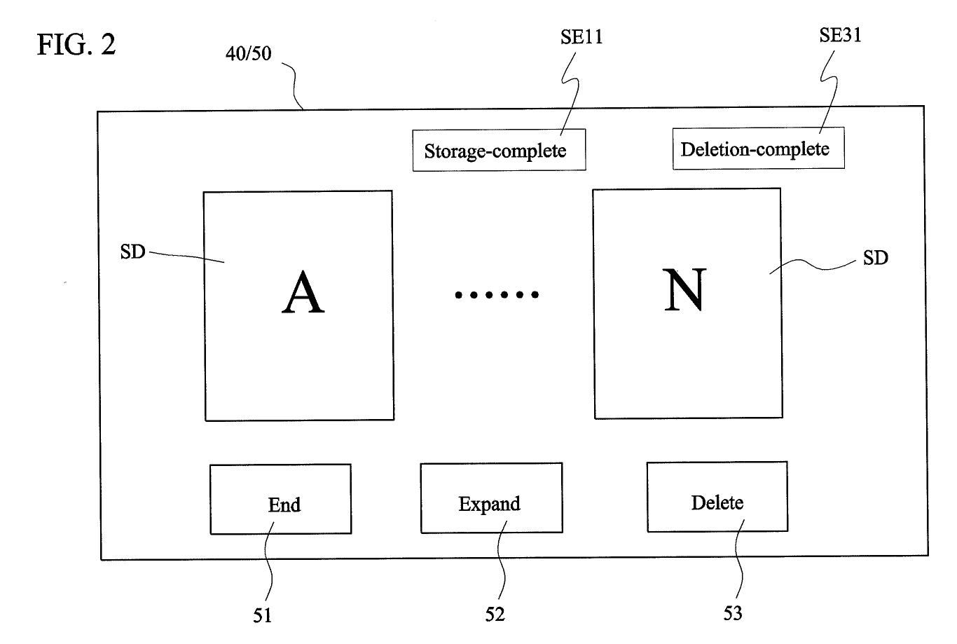

FIG. 1 is a schematic illustration showing an apparatus for displaying and storing scan images according to the invention. FIGS. 2 to 5 show several operation states in the apparatus according to the invention. Referring to FIG. 1, the apparatus 100 of the invention includes a processor module 10, an image capturing module 30 and a display module 40. The apparatus 100 may further include a housing 9, in which the processor module 10, the image capturing module 30 and the display module 40 are disposed.

A memory device 20 is connected to the apparatus 100, by coupled to the processor module 10. The memory device 20 may be an external memory device 24, removably coupled to the processor module 10 via a connection interface 22. Alternatively, the memory device 20 may be a flash disk, an internal hard drive, a portable hard drive or the like.

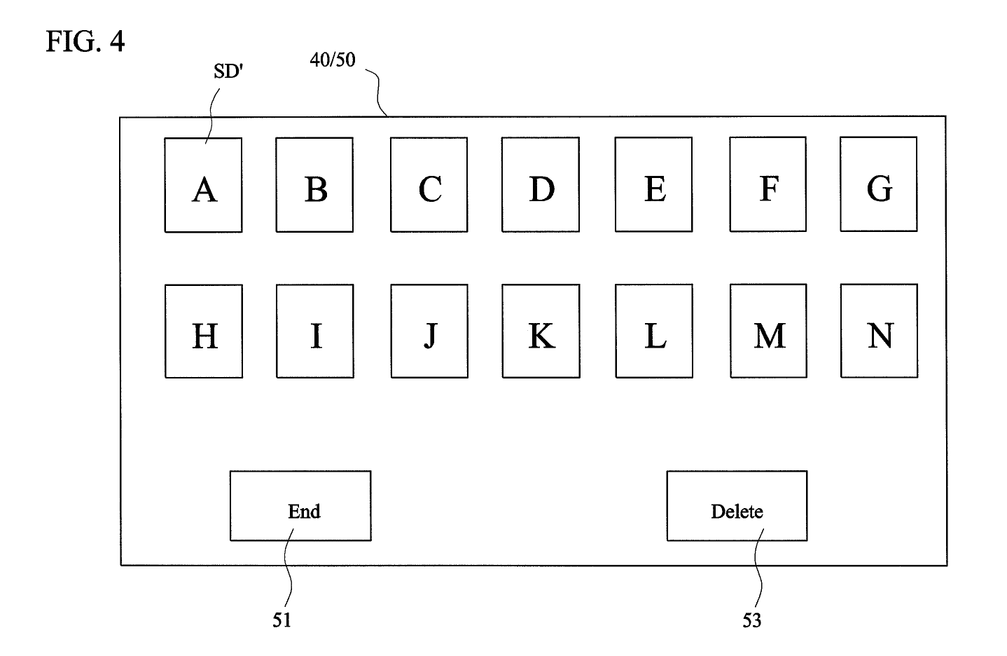

The image capturing module 30, coupled to and controlled by the processor module 10, captures N images of N pages of a document and generates corresponding N sets of image data SA, where N is a positive integer greater than 2. In FIG. 1, for example, N is equal to 4 so that the image capturing module 30 captures four images of four pages of two sheets D1 and D2 of a document. The processor module 10 processes the N sets of image data SA and generates corresponding storage image data SB and M representation images SD/SD′ of M units of the N images, where M is a positive integer less than N. The image capturing module 30 of the invention captures the N images of N pages of the document when the document is stably moved relatively to the image capturing module 30. The stable relative movement may be achieved by the stationary document in conjunction with a moving image capturing module, or by the moving document in conjunction with a stationary image capturing module. This stable relative movement may be achieved by using a sheet-fed scanner or a flatbed scanner. In FIG. 4, N is equal to 14 and the document may contain N sheets. In this case, the 14 images correspond to the single-sided images of 14 sheets. Alternatively, the document may include N/2 sheets. In this case, the N images correspond to the double-sided images of the N/2 sheets. As shown in FIG. 1, for example, the document may contain a first sheet D1 and a second sheet D2, and N is equal to 4. The first sheet D1 has a front side D1A and a back side D1B. The image capturing module 30 may include a first capturing module 32 and a second capturing module 34. The first capturing module 32 captures the image of the front side D1A, while the second capturing module 34 captures the image of the back side D1B. Alternatively, this document may be a continuous computer sheet, and the image capturing module 30 can scan N images of this continuous computer sheet.

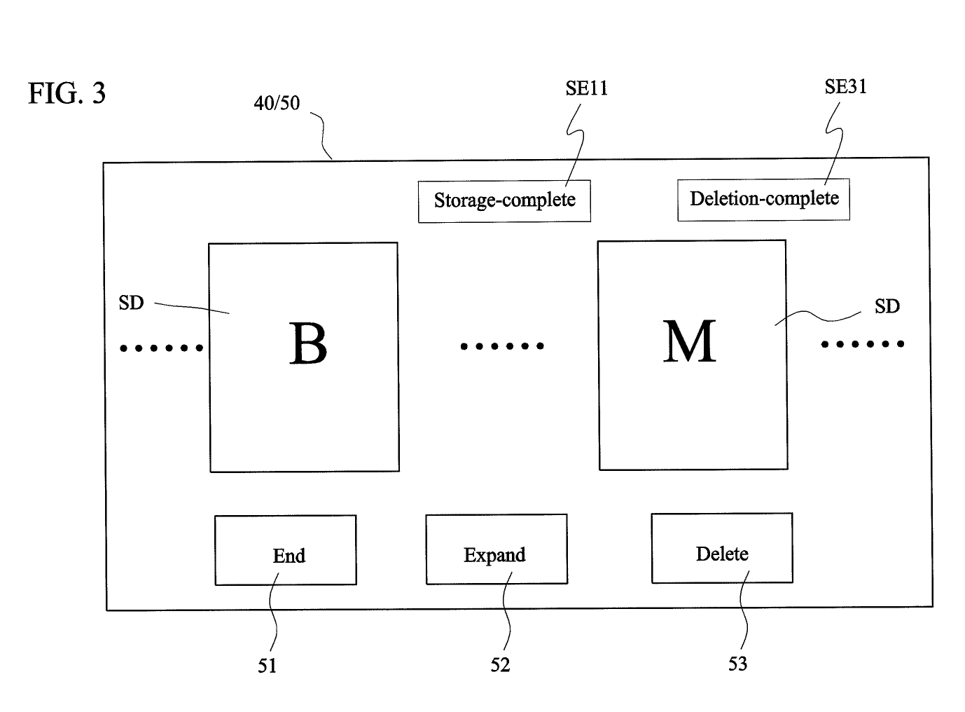

The display module 40, coupled to the processor module 10, displays the M representation images SD after the storage image data SB are stored in the memory device 20 connected to the apparatus 100. For example, as shown in FIGS. 2 and 3, M is equal to 2. Thus, when no command is inputted to the apparatus 100 of the invention, the display module 40 of the invention may automatically and directly display at least the two representation images of the document after the image capturing module 30 scans the document. So, the user can verify the scan result immediately without inputting any command via complex keystrokes.

In addition, the apparatus may further include an operation interface module 50, coupled to the processor module 10, for receiving user input and generating an operation signal SE to the processor module 10 according to the user input. In this embodiment, the operation interface module 50 includes three physical buttons or touch panel buttons 51 to 53 so that the user can press the buttons to generate the operation signal SE. The operation signal SE may include an ending signal SE1, which is generated when the user presses the “End” button 51.

In this case, upon receiving the operation signal SE1, the processor module 10 generates a storage-complete message SE11 to indicate that the storage image data SB have been successfully stored in the memory device 20. The storage-complete message SE11 may be processed and communicated to users via the display module 40 or a speaker 80 connected to the apparatus 100. The speaker 80, coupled to the processor module 10, converts the storage-complete message SE11 into the sound, to notify the user. The purpose of the notification is to prevent the user from incorrectly removing the portable memory device 20, like the memory card or flash disk, before the storage image data SB has been stored in the suitable format.

Alternatively, the processor module 10 may clear the M representation images SD, displayed on the display module 40, upon receiving the ending signal SE1, so that the scan operation for the next document may be proceeded. In this case, the storage-complete message SE11 is displayed only after the M representation images SD are cleared.

On the other hand, the operation signal SE may include, for example, an expansion signal SE2, generated when the user presses the “Expand” button 52. Upon receiving the expansion signal SE2, the processor module 10 further generates N representation images SD′ of the N images, and the display module 40 further displays the N representation images SD′, as shown in FIG. 4. It is to be noted that the “Expand” button is no longer needed, or the “Expand” button may be disabled, as shown in FIG. 4, because the representation images SD′ for all N images are displayed.

The operation signal SE may include a deletion signal SE3, generated when the user presses the “Delete” button 53, for example. Upon receiving the deletion signal SE3, the processor module 10 further deletes the storage image data SB stored in the memory device 20 and then generates a deletion-complete message SE31 to indicate that the storage image data SB have been successfully deleted from the memory device 20.

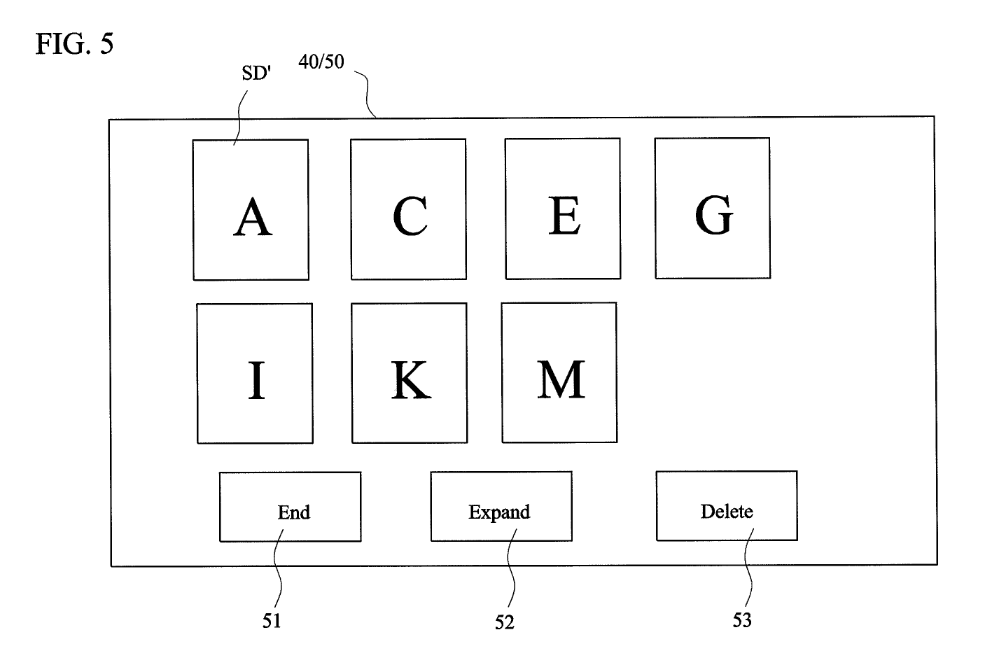

The M representation images SD may correspond to the images of the first page and the last page of the document, as shown in FIG. 2. Alternatively, the M representation images SD may correspond to two of the pages of the document, as shown in FIG. 3. Alternatively, the M representation images SD′ may correspond to odd numbered pages of images of the N sets of image data SA, as shown in FIG. 5.

The apparatus 100 may further include a random number table 70 coupled to the processor module 10, which randomly generates the M representation images SD/SD′ out of the N sets of image data SA according to the random number table 70, so that the user can randomly check whether the scanned images are correct, and ensure that the image files satisfy the user's requirement.

The apparatus 100 may further include an automatic sheet feeder 60 for transporting the N sheets of the document past the image capturing module 30 for the images of the document to be captured in a scan region SR.

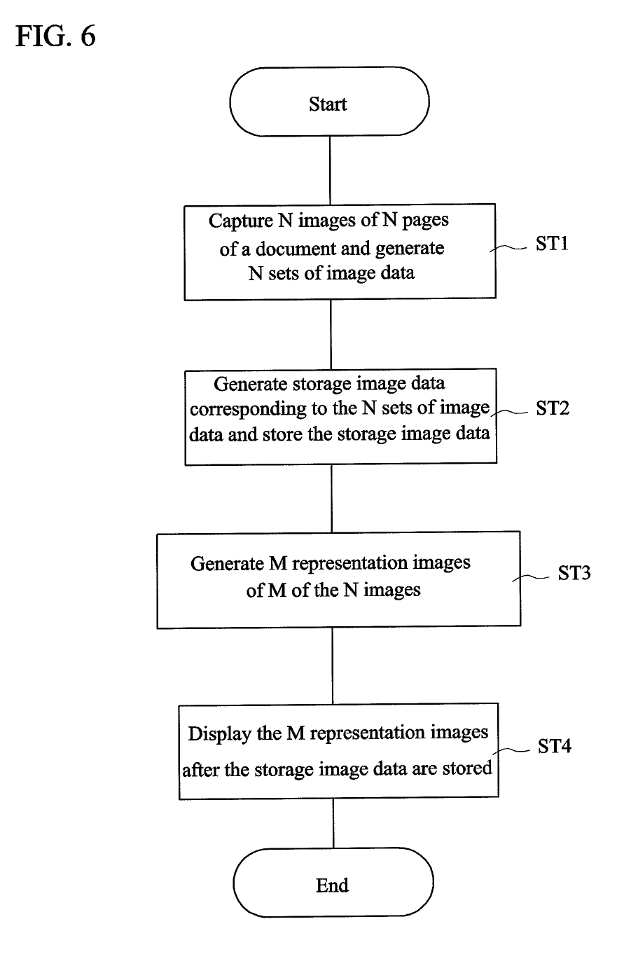

FIG. 6 is a flow chart showing a method for displaying and storing the scan images according to the invention. As shown in FIG. 6, the method of the invention, used in the apparatus 100 mentioned hereinabove, includes the following steps.

First, in step ST1, N images of N pages of a document are captured to respectively generate N sets of image data SA, where N is a positive integer greater than 2.

Next, in step ST2, storage image data SB corresponding to the N sets of image data SA are generated and stored.

Then, in step ST3, M representation images SD/SD′ of M of the N images are generated, where M is a positive integer less than N.

Next, in step ST4, the M representation images SD/SD′ are displayed after the storage image data SB are stored.

Then, the method according to the embodiment may further include the step of communicating to users, upon receiving user input, the storage-complete message SE11 to indicate that the storage image data SB have been successfully stored.

Alternatively, the method may further include the steps of generating N representation images SD/SD′ of the N images upon receiving the user input; and displaying the N representation images SD/SD′. Also, the method may further include the step of deleting the storage image data SB, upon receiving the user input, and then communicating to the users the deletion-complete message SE31 to indicate that the storage image data SB have been successfully deleted. Also, the M representation images SD, displayed on the display module 40, may be cleared upon receiving the ending signal SE1. Of course, other specific operations still can be performed.

Thus, this invention facilitates the verification of the scanned image and prevents the user from improperly removing the portable memory device. In addition, the apparatus of this invention incorporates the functions and devices for displaying and storing the image data in one single footprint, so the user need only operate the apparatus, instead of operating both the scanner and computer. Furthermore, the apparatus of this invention displays only a sufficient number of representation images for the user to check the content of the scan results, which will improve the transmission and processing speed of the data. With less data size, the representation image data take up less bandwidth of the memory buffer in the processor module, which allows the processing circuits a faster access to the memory buffer and, in result, optimizes the performance of the apparatus.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An apparatus for displaying and storing scan images, comprising:
an image capturing module for capturing N images of N pages of a document and generating corresponding N sets of image data, wherein N is a positive integer greater than 2;
a processor module, coupled to the image capturing module, for controlling the image capturing module and for processing the N sets of image data and generating corresponding storage image data and M representation images of M of the N images, wherein M is a positive integer less than N; and
a display module, coupled to the processor module, for displaying the M representation images after the storage image data are stored in a memory device connected to the apparatus.

2. The apparatus according to claim 1, further comprising:
an operation interface module, coupled to the processor module, for receiving user input and generating an operation signal to the processor module according to the user input.

3. The apparatus according to claim 2, wherein upon receiving the operation signal, the processor module further generates a storage-complete message to indicate that the storage image data have been successfully stored in the memory device.

4. The apparatus according to claim 3, wherein the storage-complete message is processed and communicated to users via the display module or a speaker connected to the apparatus.

5. The apparatus according to claim 2, wherein upon receiving the operation signal, the processor module further generates N representation images of the N images, and the display module further displays the N representation images.

6. The apparatus according to claim 2, wherein upon receiving the operation signal, the processor module further deletes the storage image data stored in the memory device and then generates a deletion-complete message to indicate that the storage image data have been successfully deleted from the memory device.

7. The apparatus according to claim 1, wherein the M representation images correspond to images of a first page and a last page of the document.

8. The apparatus according to claim 1, wherein the processor module randomly generates the M representation images out of the N sets of image data.

9. The apparatus according to claim 1, further comprising an automatic sheet feeder for transporting the document past the image capturing module for the images of the document to be captured.

10. The apparatus according to claim 1, wherein the memory device is an external memory device, removably coupled to the apparatus via a connection interface.

11. The apparatus according to claim 1, further comprising a housing, wherein the processor module, the image capturing module and the display module are disposed in the housing.

12. A method for displaying and storing scan images, used in an apparatus, the method comprising the steps of:
capturing N images of N pages of a document and generating N sets of image data, wherein N is a positive integer greater than 2;
generating storage image data corresponding to the N sets of image data and storing the storage image data;
generating M representation images of M of the N images, wherein M is a positive integer less than N; and
displaying the M representation images after the storage image data are stored.

13. The method according to claim 12, further comprising the step of:
communicating to users, upon receiving user input, a storage-complete message to indicate that the storage image data have been successfully stored.

14. The method according to claim 12, further comprising the steps of:
generating N representation images of the N images upon receiving user input; and
displaying the N representation images.

15. The method according to claim 12, further comprising the step of:
deleting the storage image data, upon receiving user input, and then communicating to users a deletion-complete message to indicate that the storage image data have been successfully deleted.
